(19) United States
(12) Patent Application Publication
(10) Pub. No.: US 2025/0188907 A1
(43) Pub. Date: Jun. 12, 2025

(54) WIND HARNESS FOR A VEHICLE

(71) Applicant: FCA US LLC, Auburn Hills, MI (US)

(72) Inventor: Azad Mohammed Shaik, Troy, MI (US)

(21) Appl. No.: 18/536,786

(22) Filed: Dec. 12, 2023

(51) Int. Cl. F03D 9/32; B60R 16/03; F03D 1/04; H02K 7/18

(52) U.S. Cl. CPC F03D 9/32; F03D 1/04; H02K 7/183; F05B 2240/941

(57) ABSTRACT

A wind harness for a vehicle has a chute with a first end and a second end. A plurality of vanes, in the chute, extend from the first end of the second end of the chute. A plurality of ducts, in the chute, extend from the first end to the second end of the chute to direct air flow from the first to the second end. At least one turbine is positioned adjacent the second end of the chute. The turbine is activated by the air flow to generate electricity.

### FIELD

The present disclosure relates to vehicles and, more particularly, to a wind harness utilizing wind to produce electrical energy.

### BACKGROUND

This section provides background information related to the present disclosure which is not necessarily prior art.

In automotive vehicles, when they are moving, they are constantly exposed to a wind force. Ordinarily, as the vehicle speed increases, the force of the wind around the vehicle increases. Thus, there is wind or air present at a significant speed. Thus, it would be desirable to utilize the wind speed and force to generate electricity via a wind turbine. Several different types of electrical generation devices have been provided in the art. However, these devices have drawbacks when applying them to the vehicle to generate electricity.

Thus, it would be desirable to utilize the wind hitting the vehicle and harnessing the wind to generate electricity. Accordingly, the present disclosure provides a wind harnessing device.

The present device provides a wind harness having a chute in the grille of the vehicle. The chute is angled from the vehicle grille to enable the air flow through the harness. The harness directs air to turbines when the car is moving so that the air flows through the harness and generates electricity via the wind turbine.

### SUMMARY

This section provides a general summary of the disclosure, and is not a comprehensive disclosure of its full scope or all of its features.

According to a first aspect of the disclosure, a wind harness for a vehicle comprises a chute having a first end and a second end. A plurality of ducts, in the chute, extend from the first end to the second end of the chute to direct an air flow from the first to the second end. A plurality of vanes, in the chute, extend from the first end to the second end of the chute. At least one turbine is positioned at the second end of the chute. The turbine is activated by the air flow to generate electricity. The plurality of ducts and plurality of vanes are horizontally stacked upon one another. The plurality of vanes includes a wedge directing the air flow toward the turbine. The plurality of vanes include a blunt end at the first end of the chute. The plurality of vanes are angled in the flow direction. The chute is angled along the flow direction.

According to a second aspect of the disclosure, a vehicle with a wind harness comprises a front grille on a body of the vehicle. A chute, with a first end and second end, is positioned on the grille. A plurality of ducts, in the chute, extend from the first end to the second end of the chute to direct an air flow from the first to the second end. A plurality of vanes, in the chute, extend from the first end to the second end of the chute. At least one turbine is positioned at the second end of the chute. The turbine is activated by the air flow to generate electricity. The plurality of ducts and plurality of vanes are horizontally stacked upon one another. The plurality of vanes includes a wedge directing the air flow toward the turbine. The plurality of vanes include a blunt end at the first end of the chute. The plurality of vanes are angled in the flow direction. The chute is angled along the flow direction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view of a vehicle with a wind harness.

FIG. 2 is an enlarged view of the wind harness.

FIG. 3 is a cross-section view of the wind harness.

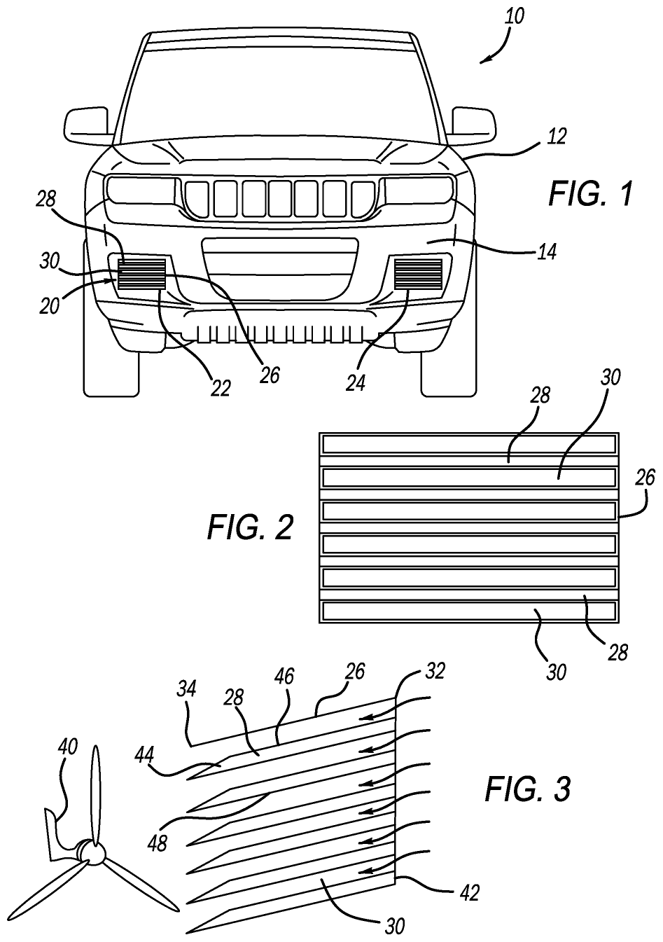

Corresponding reference numerals indicate corresponding parts throughout the several views of the drawings.

### DETAILED DESCRIPTION

Example embodiments will now be described more fully with reference to the accompanying drawings.

Turning to figures, a vehicle is illustrated and designated with the reference numeral 10. The vehicle 10 includes a body 12. The body 12 includes a front grille 14. The grille 14 is positioned at the front of the vehicle to receive air flow when the vehicle is moving.

A wind harness 20 is illustrated integrated into the front grille 14. As shown, the wind harness 20 includes a first air receiving chute 22 and a second air receiving chute 24. The wind receiving chutes 22, 24 are substantially identical and the detailed description of one will apply to both.

The chute 22, 24 is positioned in the grille 14. The chute 22 has a perimeter wall 26 divided by a plurality of vanes 28 and ducts 30. The chute 22 has a first end 32 and a second end 34. The first end 32 is at the front of the vehicle to receive the air flow. The second end 34 is positioned adjacent a turbine 40. The chute 22 is defined by a perimeter wall 26 illustrated having a rectangle shape in the figures. The wall 26 and chute 22, 24 are angled with respect to the axis of the vehicle 10 to provide a downward directed chute to direct the air flow toward the turbine 40.

The vanes 28 include a blunt end 42 at the first end of the chute 22, 24. The blunt end 42 enables the air flow to be directed into the plurality of adjacent ducts 30. The vanes 28 are angled with the chute 22 with respect to the axis of the vehicle. The vanes 28 direct the air flow toward the air turbine 40. The vanes 28 include a second tapered end 44 to direct the air flow toward the air turbine 40. The tapered ends 44 act as nozzles to provide the air flow to the air turbine 40. The vanes 28 extend across the chute 22 between the walls 26, and have a top surface 46 and bottom surface 48. The surfaces generally define the channels or ducts 30 between the top and bottom surfaces of the vanes 28. The top vane surface 46 defines a duct with the perimeter wall 26 of the chute 22, 24. Thus, the ducts 30 are angled with respect to the axis of the vehicle. The air flow enters the first end of the chute 22, 24 and is directed to the air turbine 40 via the channels or ducts 30.

The air flow is directed towards the air turbine 40. One or more air turbines 40 may be positioned at the end of the chute 22, 24. However, at least one air turbine 40 is positioned at the end of each chute 22, 24. Thus, there are at least two air turbines 40 to receive the two air flows through the air receiving chutes 22, 24. Each air flow has its own air turbine 40 separate from the other. The air turbines 40 generate the electricity, via the air flow, to the vehicle.

Thus, as the vehicle is driven, the vehicle creates an air flow that is forced into the ducts 30 between the plurality of vanes 28. The air flow is directed in the plurality of ducts 30 towards the air turbine 40. As the air flow approaches the end of the vanes 28, the tapered nozzle end 44 directs the air flow to the air turbine increasing the air flow speed to generate electricity.

The trough 22 may be a pipe that has been cut in half having a concave surface 24 to receive the air flow. The trough 22 generally has ends 26 that terminate the trough 22 so that the air flows stays in the trough 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-12. (canceled)

13. An air receiving system (20) configured to be integrated into a front grille (14) of a vehicle (10) that is configured to receive a flow of air, the air receiving system (20) comprising:
at least one chute (22 or 24) configured to receive and direct air while the vehicle (10) is in motion; and
at least one turbine (40) positioned proximate the at least one chute (22 or 24) that is driven by the air that is received and directed by the at least one chute to generate electricity for the vehicle,
wherein the at least one chute (22 or 24) includes:
a perimeter wall (26) that defines an upper surface of the at least one chute, the upper surface extending between a first end (32) of the at least one chute that receives the air and an opposite second end (34) positioned proximate the at least one turbine (40), and the perimeter wall defining a pair of side surfaces of the at least one chute that are connected to the first end (32) of the upper surface and extend in downward direction from the upper surface; and
a plurality of vanes (28) that are positioned in the at least one chute (22 or 24), and each of which extend laterally between the pair of side surfaces of the perimeter wall (26), the plurality of vanes (28) being vertically spaced apart from each other in the downward direction from the upper surface such that a plurality of gaps are defined, with each gap being provided between an adjacent pair of vanes (28) and defining an air-receiving duct (30) for directing the air towards the at least one turbine (40).

14. The air receiving system according to claim 13, wherein each vane includes a proximate end (42) attached to the side surfaces of the perimeter wall (26) and a tapered distal end (44) positioned proximate the at least one turbine (40)

15. The air receiving system according to claim 14, wherein the tapered distal end (44) acts as a nozzle of the duct (30) that directs the air in the duct (30) toward the at least one turbine (40).

16. The air receiving system according to claim 14, wherein each vane (28) is angled in the downward direction relative to a longitudinal axis of the vehicle that extends in parallel with the ground.

17. The air receiving system according to claim 13, further comprising a second chute and a second turbine positioned proximate the second chute.

18. A vehicle comprising:
a body (12);
a front grille (14) attached to the body (12) that is configured to receive a flow of air while the vehicle (10) is in motion; and
an air receiving system (20) integrated into the front grille (14),
wherein the air receiving system (20) includes:
at least one chute (22 or 24) configured to receive and direct air while the vehicle (10) is in motion; and
at least one turbine (40) positioned proximate the at least one chute (22 or 24) that is driven by the air that is received and directed by the at least one chute to generate electricity for the vehicle,
wherein the at least one chute (22 or 24) includes:
a perimeter wall (26) that defines an upper surface of the at least one chute, the upper surface extending between a first end (32) of the at least one chute that receives the air and an opposite second end (34) positioned proximate the at least one turbine (40), and the perimeter wall defining a pair of side surfaces (FIG. 2) of the at least one chute that are connected to the first end (32) of the upper surface and extend in downward direction from the upper surface; and
a plurality of vanes (28) that are positioned in the at least one chute (22 or 24), and each of which extend laterally between the pair of side surfaces of the perimeter wall (26), the plurality of vanes (28) being vertically spaced apart from each other in the downward direction from the upper surface such that a plurality of gaps are defined, with each gap being provided between an adjacent pair of vanes (28) and defining an air-receiving duct (30) for directing the air towards the at least one turbine (40).

19. The vehicle according to claim 18, wherein each vane includes a proximate end (42) attached to the side surfaces of the perimeter wall (26) and a tapered distal end (44) positioned proximate the at least one turbine (40)

20. The vehicle according to claim 19, wherein the tapered distal end (44) acts as a nozzle of the duct (30) that directs the air in the duct (30) toward the at least one turbine (40).

21. The vehicle according to claim 19, wherein each vane (28) is angled in the downward direction relative to a longitudinal axis of the vehicle (10) that extends in parallel with the ground.

22. The vehicle according to claim 18, wherein the air receiving system (20) includes a second chute (24) provided in the front grille (14) and a second turbine (40) positioned proximate the second chute (24).
